(19) United States
(12) Patent Application Publication
(10) Pub. No.: US 2026/0042411 A1
(43) Pub. Date: Feb. 12, 2026

(54) MECHANICALLY LATCHING RESTRAINT CYLINDER

(71) Applicant: Skyline Design LLC, Orlando, FL (US)

(72) Inventor: Jeffrey Pike, Walton, KY (US)

(21) Appl. No.: 19/291,822

(22) Filed: Aug. 6, 2025

Related U.S. Application Data
(60) Provisional application No. 63/680,882, filed on Aug. 8, 2024.

(51) Int. Cl. B60R 21/02; B60R 21/00

(52) U.S. Cl. CPC B60R 21/02; B60R 2021/0097; B60R 2021/0213; B60R 2021/022

(57) ABSTRACT

A mechanically latching restraint cylinder is provided. A torsionally rigid, rotating assembly inside the restraint cylinder is rotatable between a locked position, where a locking pawl of a slider carried by the rotating assembly engages teeth inside a tube of the cylinder, and an unlocked position, where the pawl does not engage the teeth and the slider can freely travel along the longitudinal axis of the tube.

### CROSS-REFERENCE TO RELATED APPLICATIONS

The present application claims the priority, under 35 U.S.C. § 119(e), of U.S. Provisional Ser. No. 63/680,882 filed on Aug. 8, 2024; That application being incorporated herein, by reference, in its entirety.

### BACKGROUND OF THE INVENTION

### Field of the Invention

The present invention relates to mechanically latching restraint cylinder and, more particularly, to a mechanically latching restraint cylinder used to lock a mechanical restraint for an amusement device or ride conveyance.

### Description of the Related Art

The amusement park industry safely conveys millions upon millions of people worldwide on various amusement devices that feature various assemblies intended to restrain or otherwise keep riders in a proper riding position. To be considered for use on amusement rides, the function and design of these devices generally need to satisfy a particular ride design standard, such as DIN EN 13814, ASTM F2291 or other standards developed by individual operators. Restraint devices used to protect the rider and maintain them in the proper riding position include lapbars and/or over-the-shoulder restraints or harnesses, among others.

Referring now to FIG. 1, there is shown one such type of restraint device in accordance with the prior art. A restraint arm 20 of a lapbar or harness contacts a rider seated in the passenger seat 10 in a particular way to keep the passenger contained within the ride conveyance. The restraint arm 20 of the lapbar or harness is then ‘locked’ into place by a device that prevents unwanted movement or disengagement of the device. This is referred to as the “locking mechanism” in standard industry parlance. In the prior art, a hydraulic cylinder 30 has been used as the “locking mechanism” to lock the restraint arm 20 of the lapbar or harness in a closed position that contains the passenger in a ride conveyance. See, for example, U.S. Pat. No. 4,005,877 to Humphries.

More particularly, in the example shown in FIG. 1, the restraint arm 20 is a “U” shaped over-the-shoulder (OTS) harness including a horizontal lapbar portion 22 that is formed integrally with two side arms 22a that are pivotally mounted at a shaft 24 behind the headrest 14 of the passenger seat 10. The passenger restraint bar 20 is thus pivotable with respect to the passenger seat 10 from an extreme upward position U (shown in dotted outline in FIG. 1) that permits a passenger to get into and out of the passenger seat 10, to a lower most, down position D (also shown in dotted outline in FIG. 1). A hydraulic cylinder 30 provides a locking mechanism for the restraining arm 20. A shaft 32 of the hydraulic cylinder is connected between an internal piston of the hydraulic cylinder 30 and the rotating shaft 24 of the restraining arm 20, to convert a pivotal motion of the restraining arm 20 to a linear motion of the internal piston of the hydraulic cylinder 30, when the hydraulic cylinder 30 is in the unlocked state. Typically, one or more hydraulic cylinders 30 is/are positioned generally vertically behind the seat 10.

FIG. 2 is an illustration of a hydraulic cylinder 50 of the prior art. One advantage to using a hydraulic cylinder 50 as a locking mechanism is that the hydraulic cylinder 50 generally interfaces with the restraint equipment at only three well-defined locations: 1) the head-end rod 52, which is a clevis or spherical rod end configured to accept a single pin; 2) the rear-end rod 54, which is also a clevis or spherical rod end, like the head-end rod; and 3) an electrical connector 56, which carries the required current and voltage to activate and/or release the lock.

Because of their simple design, hydraulic cylinders with a one-way or two-way blocking valve have been developed by various hydraulic manufacturers, for use by ride manufacturers as the primary or secondary locking mechanism on hundreds of attractions globally. One such hydraulic cylinder is disclosed in U.S. patent application Ser. No. 11/465,062 to Ahle.

Unfortunately, these designs have inherent drawbacks for the owner and operator. Primarily, the hydraulic fluids in the cylinder must be kept free of contaminants. Additionally, the nature of the high-pressure seals requires that the hydraulic cylinders be subject to a shelf life of between 7 and 10 years, regardless of use. This means that the owner or operator has to completely replace the entire set of all cylinders every 7 years, which is very expensive for an operator who has deployed these systems across hundreds of attractions, representing many thousands of cylinders per year.

Additionally, periodic testing of the systems to verify proper function can consume hours of maintenance time every week, while parks are struggling to keep sufficient staff levels to properly maintain all of their existing inventory. These tests verify that no air has managed to enter the closed hydraulic system and caused a weakness in the operation, and to verify that seals have not degraded and will not allow a slow leak of oil past the seals. By their nature, they require several hours to perform and constitute a significant portion of the maintenance tasks associated with vehicles that use hydraulic cylinders.

Locking linear actuators and linear blocking apparatus that are not hydraulic have also been disclosed in the art. For example, U.S. Pat. No. 10,569,731 to Thiele (“Thiele”) discloses a linear blocking apparatus having a linear device which is longitudinally displaceable along an axis and is guided in a housing. See, for example, the Title and Abstract of Thiele. The system of Thiele uses a modular system for the securement and release of persons, objects or the like. See, for example, col. 1 of Thiele, lines 27-28. Among other things, the Thiele reference discloses a rotary unit that has a spindle, in particular, a ball screw having a coarse thread. See, for example, col. 3 of Thiele, lines 55-59.

U.S. Pat. No. 8,844,389 to Kopacek (“Kopacek”) discloses an automatically locking linear actuator including a first end connector, a rotatable drive screw operably coupled to the first end connector, a nut assembly threadably mounted on the drive screw, a second end connector operably coupled to the nut assembly and a rotary lock having a rotor and where the actuator moves between extended and retracted positions in response to rotation of the rotor. See, for example, the Abstract of Kopecek.

U.S. Patent Application Publication No. 2006/0081079 to Jaecklin et al (“Jaecklin”) discloses a linear drive with emergency adjustment possibility. See, for example, the title of Jaecklin. Among other things, the Jaecklin reference discloses the use of a spindle, which may have a non-self-locking or a self-locking external thread, and a threaded nut located on the spindle. See, for example, paragraphs [0028] and [0029] of Jaecklin.

What is needed is a latching restraint cylinder that does not rely on hydraulic fluid and a blocking valve to accomplish locking, but rather, has a simple mechanical mechanism to reliably lock a passenger restraint in a ride conveyance. What is further needed is a mechanically latching restraint cylinder that utilizes a mechanism that operates more simply than those operating on the basis of moving a nut assembly linearly on a threaded spindle or drive screw. What is further needed is a mechanically latching restraint cylinder that has the same form factor as a hydraulic cylinder of the prior art.

### BRIEF SUMMARY OF THE INVENTION

The present invention is particularly suited to meet the above-described needs in a manner not previously known or contemplated. It is accordingly an object of the invention to provide a mechanically latching restraint cylinder having the same or similar form factor to the hydraulic restraint cylinders currently in use, but without relying on a hydraulic fluid and blocking valve to accomplish the locking task. Thus, a mechanically latching restraint cylinder according to the invention can be substituted for a hydraulic cylinder of the same form factor in pre-existing installations.

It is a further object to provide a mechanically latching restraint cylinder that utilizes a mechanism that operates differently from those that move a nut assembly linearly on a threaded spindle or drive screw. In one particular embodiment of the present invention, a torsionally rigid, rotating slide assembly inside the restraint assembly is rotatable between a locked position, where a locking pawl engages teeth inside a tube of the cylinder, and an unlocked position, where the pawl does not engage the teeth.

Although the invention is illustrated and described herein as embodied in a mechanically latching restraint cylinder, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The foregoing background, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentalities disclosed. Additionally, like reference numerals represent like items throughout the drawings. In the drawings:

FIG. 1 is a side plan view of a seat structure including a passenger restraint in accordance with the prior art;

FIG. 2 is a side plan view showing a prior art hydraulic cylinder;

FIG. 3 is a cutaway, perspective view of a mechanically latching restraint cylinder in accordance with one particular embodiment of the invention;

FIG. 4 is an enlarged view of a portion of the mechanically latching restraint cylinder of FIG. 3;

FIG. 5 is an enlarged view of another portion of the mechanically latching restraint cylinder of FIG. 3;

FIG. 6 is a partial, sectional view of rotational slider assembly disposed in an unlocked position in the cylinder in accordance with one particular embodiment of the invention;

FIG. 7 is a partial, cross-sectional view of mechanically latching restraint cylinder shown in a locked position in accordance with one particular embodiment of the invention;

FIG. 8 is a partial, cross-sectional view of mechanically latching restraint cylinder shown in an unlocked position in accordance with one particular embodiment of the invention;

FIG. 9A is a side plan view of a seat structure including a passenger restraint in accordance with one embodiment of the invention; and

FIG. 9B is a side plan view of a seat structure including a passenger restraint in accordance with another embodiment of the invention.

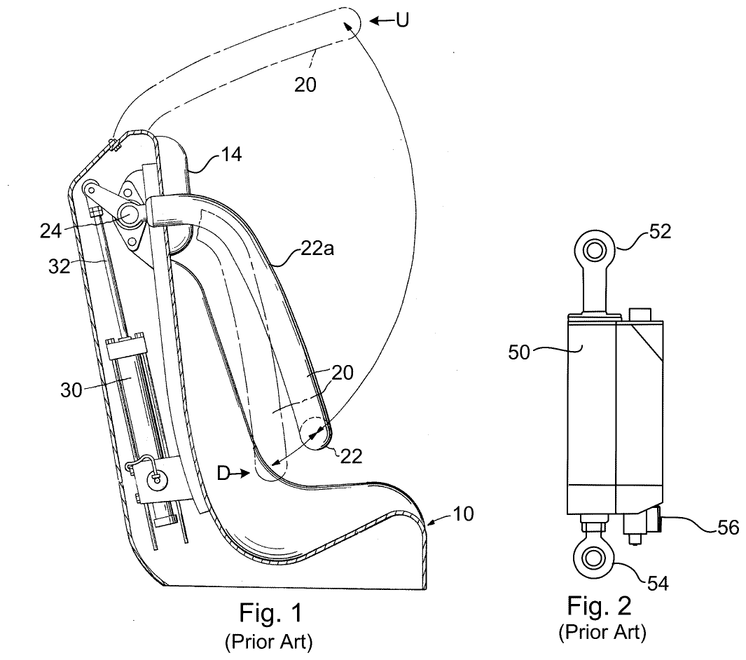

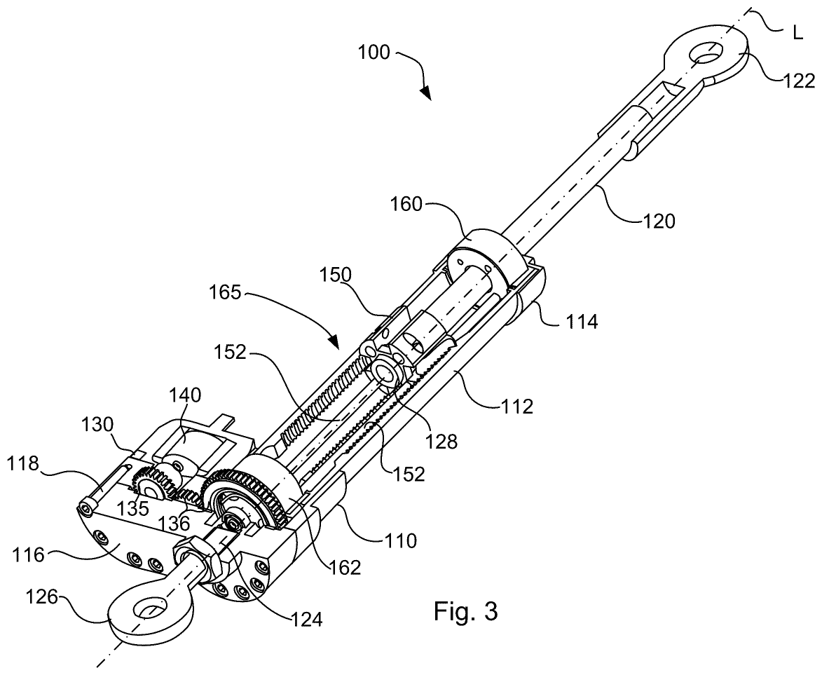

### DETAILED DESCRIPTION OF THE INVENTION

Before explaining the disclosed embodiment of the present invention in detail, it is to be understood that the invention is not limited in its application only to the details of the particular arrangement shown since the invention is capable of other embodiments. Also, the terminology used herein is for the purpose of description and not of limitation.

In the description of the exemplary embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true.

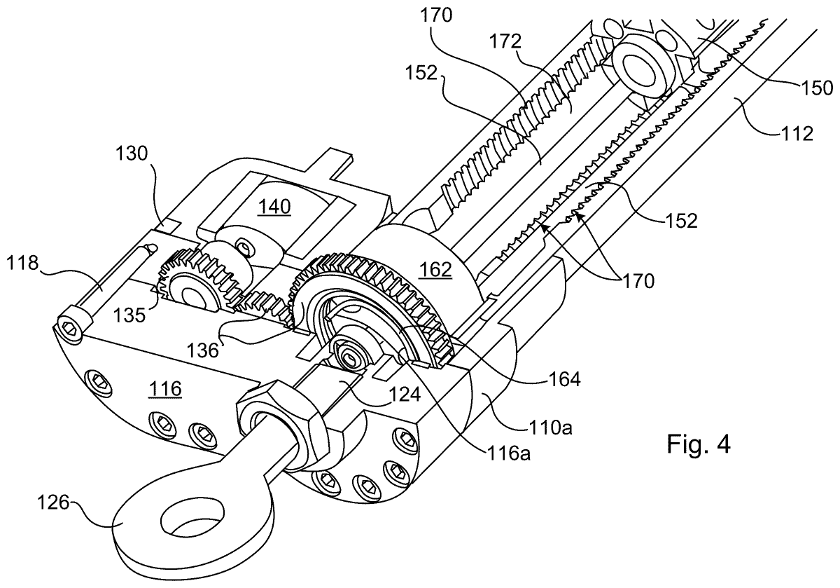

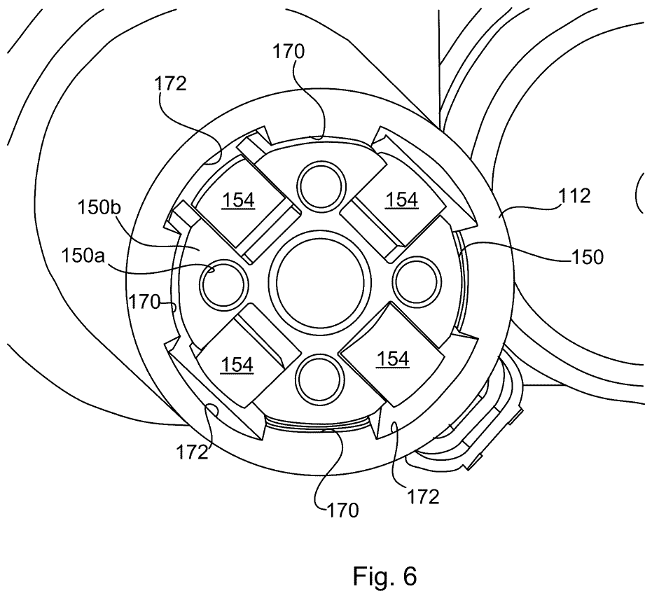

Referring now to FIG. 3-9B, there will be described particular embodiments of a mechanically latching restraint cylinder 100 in accordance with one particular embodiment of the invention. The restraint cylinder 100 has the same form factor as known hydraulic restraint cylinders, but instead of relying on hydraulic fluid and a blocking valve, a mechanical mechanism is provided inside the housing 110 of the cylinder 100, itself. This will allow a 1:1 replacement for existing hydraulic cylinders, by the mechanically latching restraint cylinder according to the invention. Such a replacement will eliminate the shelf life and arduous daily periodic maintenance procedures associate with current hydraulic restraint cylinders.

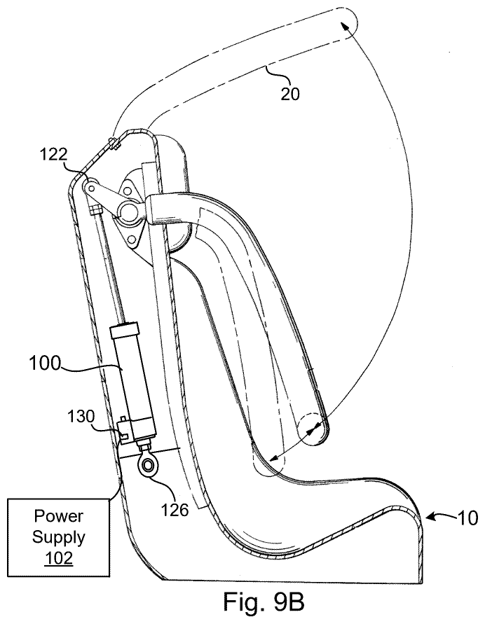

More particularly, the mechanically latching restraint cylinder 100 is configured to utilize the same or similar form factor, mounting envelope, electrical current and voltage as known hydraulic restraint cylinders. Additionally, the restraint cylinder 100 is configured to interface with existing restraint equipment at the same three locations: 1) at the head-end of the piston rod 120, via the clevis 122; 2) at the rear-end of the rod 124, via the clevis 126; and 3) via an electrical connector 130. In one particular embodiment of the invention, the electrical connector 130 is configured to mate with most existing electrical platforms, which require a 24 Volt electrical feed and would provide approximately 1 Amp of current to a solenoid or motor 140 of the restraint cylinder 100. Thus, a power supply 102 of the system or ride conveyance of an amusement ride can provide the power to one or more mechanically latching restraint cylinder(s) 100 mounted to a seat structure 10 and connected to the existing restraint equipment 20, 40 (FIGS. 9A and 9B).

A housing 110 of the restraint cylinder 100 includes a cylindrical tube 112 disposed between a top end cap 114 and a bottom end cap 116. A primary longitudinal axis L of the cylindrical tube 112 is aligned with the piston rod 120. Piston rod 120 is affixed to a slider 150 inside the cylindrical tube 112, such that the slider 150 is free to rotate about the piston rod 120, but is rigidly fixed to the piston rod 120 with a nut 128 such that the slider 150 will travel with the piston rod 120 as the piston rod 120 extends into and out of the tube 112.

The slider 150 is assembled onto a series of slider rods 152, via the holes 150a through the lobes 150b of the slider 150. Slider rods 152 are not threaded, but rather, have a smooth surface so that the slider 150 can freely slide on them. In one particularly preferred embodiment, four slider rods 152 are provided, which pass through the four holes 150a, respectively of the slider 150.

The slider rods 152 are arranged between, and affixed into, a head cap 160 and a base cap 162, such that the slider 150, itself, can freely slide on the slider rods 152, along the longitudinal axis L of the tube 112. Note that some slider rods 152 are not shown, for clarity of illustration. Together, the slider rods 152, head cap 160 and base cap 162 form a torsionally rigid, rotating assembly 165 that rotates together, as a unit, inside the housing 110, and about the piston rod 120, but that, as a unit, cannot slide in the housing 110 along the longitudinal axis L of the tube 112. The slider 150 is entrapped on the rods 152 and, thus, jointly rotates with the rotating assembly 165, but is additionally configured to slide along the longitudinal axis L of the tube 112 on the rails 152 through its connection to the piston rod 120.

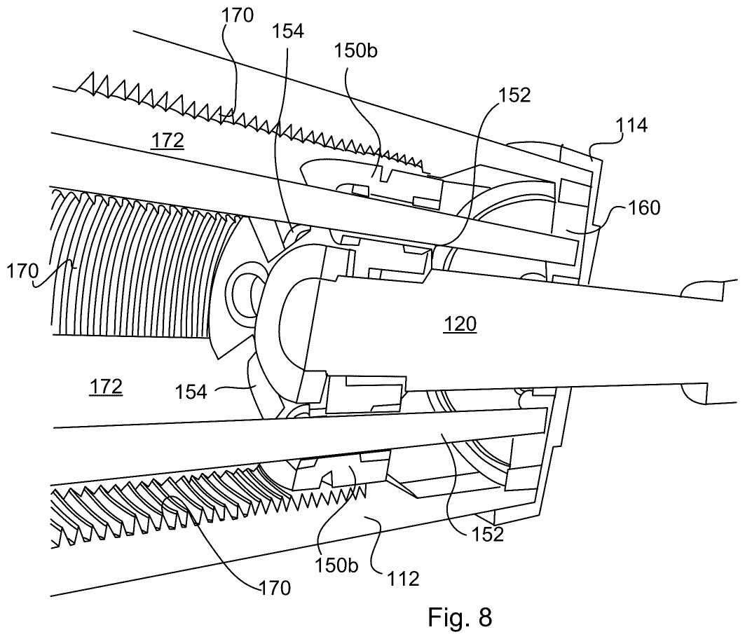

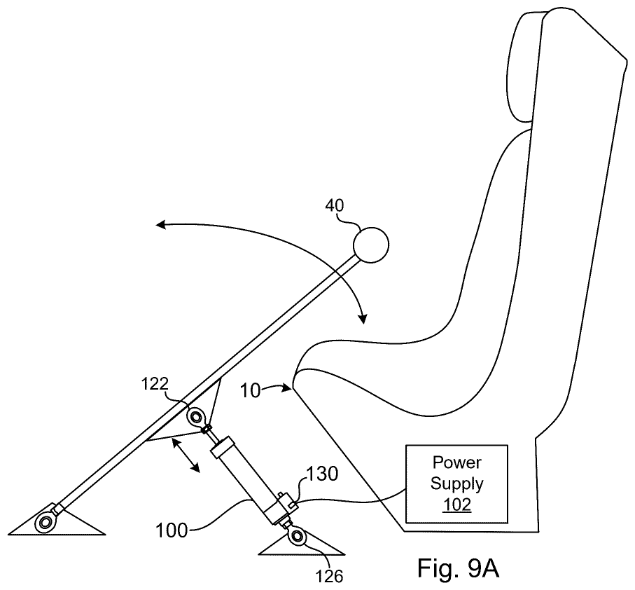

Consequently, the rotational orientation (i.e., angular position) of the slider 150 about the longitudinal axis L of the tube 112 is defined by the rotational orientation of the rotating assembly 165. Changing the rotational orientation of the rotating assembly 165 will move the slider 150 between an unlocked position (FIG. 8) in which the slider 150 is free to slide in either direction along the slider rods 152 though the tube 112, and a locked position (FIG. 7) in which the movement of the slider 150, and thus the piston rod 120, is restricted in one direction. In the present embodiment, the locked position occurs when tips 154a of the locking pawls 154, attached to the slider 150 between the lobes 150b, enmesh with teeth 170 formed in lines or columns along the inner surface of the tube 112.

More particularly, the locking pawls 154 are pinned to the slider 150 via pins 156 such that the pawls 154 can pivot about the pins 156 and extend and retract radially with respect to the primary tube axis, but are otherwise fixed to the slider 150. Springs 158 disposed between locking pawl 154 and the body of the slider 150 bias the free end of the locking pawls against the inside wall of the tube 112. Note that, although coil springs are shown, other types of springs, including other types of compression springs, may be used. For example, in another particular embodiment, the springs 158 may be urethane compression springs, if desired. Additionally, in one particular embodiment illustrated, the slider 150 has four lobes 150b that are spaced apart from one another and four spring-loaded locking pawls 154 disposed in the spaces between each two adjacent lobes.

However, the invention is not meant to be limited only to four lobes/locking pawls, as more or fewer lobes, locking pawls and/or slider rods, may be used without departing from the scope and spirit of the present invention. In such an embodiment, the rotating assembly 165 would include four sliding rails 152, one passing through a hole 150a through each lobe 150b of the slider 150, to stably link the angular position of the slider 150 to the angular position of the rotating assembly 165.

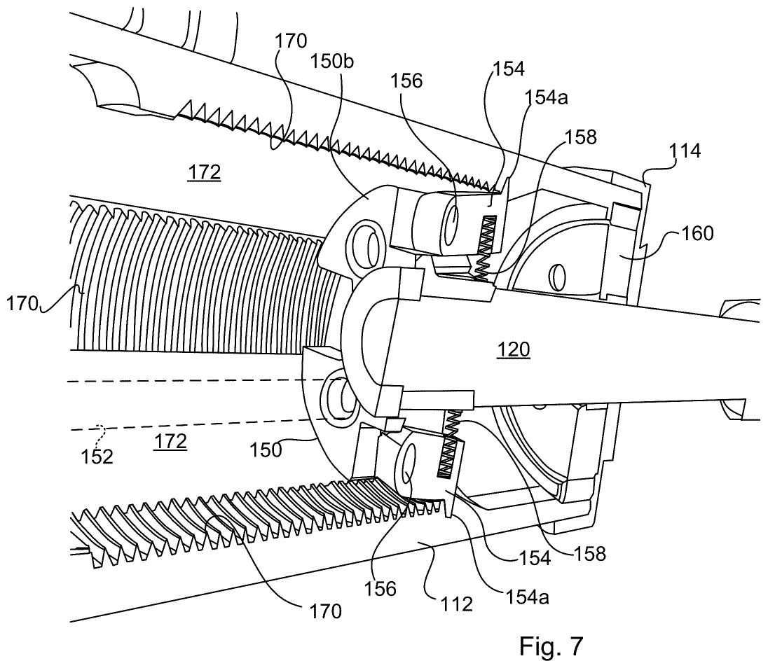

The interior surface of the cylindrical tube 120 features a geometric pattern that alternates between columns of ‘teeth’ 170 extending along the longitudinal axis L and relatively smooth, grooves or columns 172 extending along the longitudinal axis L between two neighboring columns of teeth 170. More particularly, the columns of teeth 170 are machined into the interior of the tube 112 circumferentially, but are interrupted axially inside the tube 112, forming the alternating columns of teeth 170 and smooth grooves 172 along the inside of the tube and in line with the primary tube axis L. The resulting pattern is such that the columns of teeth 170 are approximately the same width (i.e., within a few thousands of an inch more or less) as the locking pawls 154, but the grooves 172 are slightly wider than the locking pawls 154, as shown more particularly in FIG. 6.

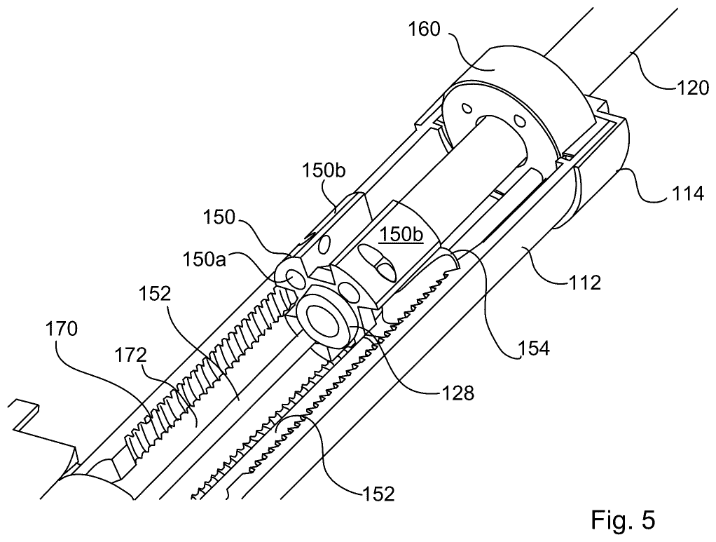

In a default position illustrated in FIG. 7, the rotating assembly (165 of FIG. 3) and slider 150 are at a position within the cylindrical tube 112, such that the pawls 154 are aligned with the teeth 170 machined into the cylinder tube 112 and the slider 150 is in the locked state. This default position is maintained via a hard stop 116a (FIG. 4) built into the end cap 116 and a torsion spring 164 that applies constant rotary pressure to the rotating assembly 165, keeping the locking pawls 154 aligned with the columns of teeth 170. In this default position, no current is flowing to the restraint cylinder 100 via the connector 130. Thus, in an unpowered state, the longitudinal position of the slider 150 is locked such that the piston rod 120 cannot be extended further from the cylindrical tube 112.

However, in the unpowered state, the piston rod 120 can be retracted into the cylindrical tube 112, via an external action that pushes the rod head-end 122 toward the cylindrical tube 112 (e.g., a patron pulling a lapbar 40 restraint to their lap), the spring-loaded locking pawls 154 are allowed to ‘ratchet’ into the teeth 170 machined into the tube 112, progressively fixing the slider 150 and piston rod 120 against further extension, but, because of the locking pawls 154, allowing further retraction, as illustrated in FIG. 7. In other words, in the unlocked position, the slider 150 is free to slide on the slider rods 152 in both directions along the longitudinal axis L of the tube 112, while in the locked position, the slider can only slide in one direction along the longitudinal axis L of the tube 112.

In the present preferred embodiment illustrated, the direction of the locking pawls 154 and the geometry of the teeth 170 are such that the piston rod 120, and correspondingly the restraint cylinder 100, is prevented from extension, but is allowed to freely retract when in the locked state. This is effective in a situation where extension of the piston rod 120 would release the restraint device, such as occurs with a lapbar 40, as illustrated in FIG. 9A. However, it should be understood that by reversing the direction of installation of the slider and also the pattern of tooth geometry, the restraint cylinder 100 can be configured such that the piston rod 120 is locked against further retraction in the default, locked state, but allows free extension of the piston rod 120 in that locked state. This can be useful in connection with an over-the-shoulder restraint, as illustrated in FIG. 9B.

Referring back to the embodiment of FIG. 3-9A, when extension of the piston rod 120 is desired (i.e. the ride reaches a parked position and is ready for passengers to disembark), an electrical signal is transmitted, via the electrical connector 130, to a rotating element such as a solenoid or motor 140. The solenoid or motor 140 thus causes the gear train 135 to rotate in kind. The gear train is in contact with mating gears 136, the teeth of which engage teeth on the base cap 162 such that rotation of the motor or solenoid element 140 will force a corresponding angular rotation of the rotating assembly 165 and the slider 150 trapped therein, when the force being applied by the gear chain overcomes the opposite torsional force of the torsion spring 164. Note that, although a single mating gear 136 is shown, more gears may be used to transmit the rotational motion from the motor 140 to the base cap 162 without departing from the spirit or scope of the invention. Additionally, it should be understood that the mating gears 136 may be omitted entirely if the assembly is adapted so that the gear train 135 drives the base cap 162 directly.

When driven by the solenoid or motor 140, the rotating assembly 165 and, correspondingly, the slider 150, rotates into a position inside the cylindrical tube 112 that aligns the locking pawls 154 with the smooth grooves 172 in the interior of the cylindrical tube 112, disengaging the locking pawls 154 from the teeth 170, and allowing the locking pawls 154 to slide freely along the smooth grooves 172 in the tube 112. In this unlocked state, the slider 150 and piston rod 120 can move freely along the longitudinal axis L of the tube 112. In an embodiment in which the slider 150 includes four lobes 150b, the motor 140 is configured to rotate the rotating assembly 165 and slider 150 by an angular displacement of about 90° in order to disengage the locking pawls 154 from the teeth 170 and align them with the smooth grooves 172. Note that the invention is not meant to be limited only thereto, as other factors (i.e., the number of lobes, the width of the columns 170 and grooves 172, etc.) will affect the angular displacement required for rotating the slider 150 between the locked and unlocked positions.

As soon as the electrical current is removed from the solenoid element 140, the torsion spring 164 once again forces the rotating assembly 165, and thus, the slider 150, to rotate to align the locking pawls 154 with the lines of machined teeth, restarting the lock cycle for the next passengers.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended. For example, although the invention is described for use as a mechanical locking device for an amusement ride restraint system, it is not meant to be limited only to that application. It should be understood that a mechanically latching restraint cylinder using a solenoid release in accordance with the invention is suitable for other uses in other industries.

Note that, although the exemplary embodiment is described as using a solenoid or motor 140, other mechanisms and devices can be used to force a rotary displacement of the rotating assembly 165 and slider 150, if desired. For example, in one embodiment of the invention, the gear train 135, 136 is replaced by belts or chains or a system of mechanical linkages. Alternately, a slide or relay mechanism may be used. Other mechanisms may additionally be used without departing from the scope and/or spirit of the invention. Further, although the anchoring devices are described as including a clevis attached to each rod end, other anchoring endpoints may be used, including, but not limited to, machined-in-place clevis tabs, blank threaded ends on the piston rod, custom terminating ends, etc.

Additionally, any series longer or shorter overall strokes (i.e., the allowable motion of the piston rod 120) can be achieved by altering the length of the tube 112, the slide rods 152, and/or the piston rod 120. Further, any interval of locking positions can be achieved by varying the pitch and number of locking teeth that are machined in the cylindrical tube 11, including only a single locking position, by machining only a single tooth, or varying positions by varying the locations of the locking teeth along the length of the tube 112.

Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

We claim:

1. A mechanically latching restraint cylinder, comprising:
a housing including a cylindrical tube;
at least one tooth disposed on an interior wall of said cylindrical tube;
a slider disposed inside said cylindrical tube and configured to slide along the longitudinal axis of said cylindrical tube;
a piston rod engaged with said slider and extending from said housing, the length of said piston rod extending from said housing depending on a position of said slider inside said cylindrical tube;
a mechanism for rotating said slider in said tube between a locked position where a portion of said slider is engaged with said at least one tooth and an unlocked position where said slider is disengaged from said at least one tooth and can freely slide along said longitudinal axis of said cylindrical tube.

2. The restraint cylinder according to claim 1, wherein said slider includes at least one locking pawl configured to engage said at least one tooth.

3. The restraint cylinder according to claim 2, wherein said at least one tooth is a plurality of columns of teeth on the inside wall of said cylindrical tube, said columns of teeth being aligned with the longitudinal axis of said cylindrical tube, a smooth groove being formed in the inside wall of said cylindrical tube between each two adjacent columns of teeth.

4. The restraint cylinder according to claim 3, wherein a width of each said column of teeth is approximately the same as the width of each said pawl.

5. The restraint cylinder according to claim 4, wherein the width of each said smooth groove is wider than the width of each said pawl.

6. The restraint cylinder according to claim 1, wherein the slider is part of a torsionally rigid rotating assembly disposed in said housing.

7. The restraint cylinder according to claim 6, wherein said rotating assembly further includes at least one slider rod in said cylindrical tube, said slider configured to slide on said at least one slider rod.

8. The restraint cylinder according to claim 7, wherein said rotating assembly further includes a first cap disposed at a first end of the cylindrical tube and a second cap disposed at a second, opposing end of said cylindrical tube, and said at least one slider rod and said slider are disposed in said cylindrical tube between said first cap and said second cap, and said rotating assembly is configured to rotate said first cap, said second cap, said at least one slider rod and said slider together as a unit.

9. The restraint cylinder according to claim 8, wherein said mechanism includes a solenoid or motor that receives electrical energy via an electrical connector of the restraint cylinder.

10. The restraint cylinder according to claim 1, further comprising a first attachment mechanism on said piston rod configured for attachment on a ride conveyance, a second attachment mechanism connected to an end of said housing opposite said first attachment mechanism, and an electrical connector configured to receive an electrical signal from outside the restraint cylinder.

11. A method for unlocking a mechanically latched restraint cylinder, comprising the steps of:
providing a mechanically latched restraint cylinder according to claim 1;
using the mechanism for rotating to rotate the slider out of engagement with said at least one tooth and into the unlocked position.

12. The method according to claim 11, wherein the step of using the mechanism for rotating includes applying an electrical signal to mechanism for rotating from outside of the mechanically latched restraint cylinder.

13. A mechanically latching restraint cylinder, comprising:
a housing including a cylindrical tube having an interior wall extending inside said cylindrical tube between a first end of said cylindrical tube and a second end of said cylindrical tube;
a plurality of teeth formed on said interior wall, at least some teeth of said plurality of teeth arranged in a column formed parallel to a longitudinal axis of said cylindrical tube;
a torsionally rigid rotating assembly disposed inside said cylindrical tube, said rotating assembly including:
a first cap located at a first end of said cylindrical tube;
a second cap located at the second end of said cylindrical tube; and
at least one slider rod extending between said first cap and said second cap;
said rotating assembly configured to be rotated in said cylindrical tube about said longitudinal axis;
a slider engaged with said rotating assembly such that angular displacement of said rotating assembly additionally angularly displaces said slider, said slider configured to slide along the longitudinal axis of said cylindrical tube on said at least one slider rod;
a piston rod engaged with said slider and extending from said housing, the length of said piston rod extending from said housing depending on a longitudinal position of said slider inside said cylindrical tube;
said slider including a locking mechanism for selectively restricting a longitudinal travel of said slider inside said tube in at least one direction;
a drive configured to rotate said rotating assembly and, resultantly, said slider attached to said rotating assembly, in said tube between a locked position having said locking mechanism engaged with at least one tooth of said column of teeth and an unlocked position where said slider is disengaged from said at least one tooth and can freely slide along said longitudinal axis of said cylindrical tube.

14. The restraint cylinder according to claim 13, wherein said rotating assembly is normally biased into said locked position and said drive is energized to rotate said rotating assembly from said locked position to said unlocked position.

15. The restraint cylinder of claim 13, wherein said locking mechanism includes at least one spring-biased locking pawl configured to engage a tooth of said column of teeth.

16. The restraint cylinder according to claim 15, wherein:
said at least one column is a plurality of columns arranged on said interior wall of said cylindrical tube;
a smooth groove is formed on said interior wall of said cylindrical tube between each two adjacent columns of teeth of said plurality of columns; and
said drive is configured to rotate said rotating assembly about said longitudinal axis, between a first angular position and a second angular position to selectively align said at least one spring-biased locking pawl with a column of teeth in said first position and with a smooth groove in said second position.

17. The restraint cylinder according to claim 16, wherein:
said slider further includes a plurality of lobes;
a spring-loaded locking pawl is disposed between each two adjacent lobes of said plurality of lobes; and
said rotating assembly includes a plurality of slider rods, each lobe of said plurality of lobes being attached to only one slider rod of said plurality of slider rods.

18. The restraint cylinder according to claim 13, wherein said second end cap is engaged with said drive such that said drive rotates said second end cap in order to rotate said rotating assembly.

19. A ride conveyance, comprising
a passenger seat;
a restraint device arranged to pivot between a closed position proximal to said passenger seat and an open position distal from said passenger seat;
the mechanically latching restraint device according to claim 1 connected to said restraint device and configured to selectively restrict movement of said slider in said locked position when said restraint device is in said closed position.

20. A method of using a ride conveyance according to claim 19, comprising the steps of:
restricting movement of the restraint device from the closed position to the open position while the mechanism for rotating is not activated; and
activating the mechanism for rotating to move the slider to the unlocked position and moving the restraint device from the closed position to the open position while the mechanism is activated.
